(19) United States
(12) Patent Application Publication
(10) Pub. No.: US 2004/0213547 A1
(43) Pub. Date: Oct. 28, 2004

(54) Method and system for video compression and resultant media

(75) Inventor: Larry T. Hayes, Grandview, MO (US)

Correspondence Address: POLSINELLI SHALTON WELTE SUELTHAUS P.C., 700 W. 47TH STREET, SUITE 1000, KANSAS CITY, MO, 64112-1802, US

(73) Assignee: Metro Interactive Digital Video, L.L.C., Kansas City, MO (US)

(21) Appl. No.: 10/063,324

(22) Filed: Apr. 11, 2002

(51) Int. Cl. H04N 5/76; G11B 27/00

(52) U.S. Cl. 386/52; 386/111

(57) ABSTRACT

The present invention relates to a method and system for compressing video. In the method and system, video is captured to a computer and encoded and compressed, whereby the resultant compressed video file is less than half, and preferably about 5% its original file size

### FIELD OF INVENTION

The present invention relates to a method and system for compressing video. More specifically, the invention relates to capturing video to a computer and encoding and compressing the video to less than half of its original file size so that, for example, five hours of video fit on a single compact disc.

### BACKGROUND OF INVENTION

Video is a series of sequential images used to show motion and changes over a period of time. These images can be stored using a variety of media, including video cassettes, compact discs, video compact discs, digital versatile discs, computer storage devices, and camcorders. A computer file is a group of instructions or data used by a computer, and a video file is a computer file containing video, or video and audio, information. Several methods exist for the transmission of video. The earliest of these was analog video. In analog video, each frame of the video is represented by a fluctuating voltage signal. One of the earliest analog video formats was composite video, which has all video components combined into one signal. Due to compositing of the video components, the quality of composite video is marginal at best. Specific problems include color bleeding, low clarity, and high generational loss.

From composite video evolved component video, which breaks the video components into separate signals. Improvements to component video have led to numerous video formats, such as S-Video, RGB, Y, Pb, and Pr. All of these are still analog formats, however, and are susceptible to quality loss from one generation to another. Generational loss with video is similar to photocopying, in which a copy of a copy results in blurred or non-distinct lines.

These limitations led to the development of digital video, which is essentially a digital representation of analog video. Unlike analog video that degrades in quality from one generation to the next, digital video does not change significantly in quality. Each generation of digital video is virtually identical to the parent. Even though the video data is digital in nature, virtually all digital formats are still stored on sequential tape. Although tape holds considerably more data than a computer hard disk, using computers and hard disks for digital video allows for random access and compression of the video.

Digital video has, in many instances, replaced analog video. As usage of digital video has grown, so has the need to transmit, store, and manipulate large amounts of video data. Digital images can be provided in many formats. Digital video is currently available through digital broadcast television, video compact discs (VCDs), digital versatile discs (DVDs), Internet streaming video, digital video cameras, video teleconferencing systems, dynamic medical imaging devices, high definition television, and other means.

Typically, video is not desired unless it looks “good” to the viewer. Obtaining video that meets this subjective measure is desired. Digital video appearance is determined by a minimum of four factors: frame rate, spatial resolution, color resolution, and image quality.

In motion pictures, television, and computer video displays, the frame rate is the number of frames or images that are projected or displayed per second. Additionally, these frames are split in half (odd lines and even lines), to form what are called “fields.” There is a difference in the way computers and televisions display video. When a television set in the United States displays its analog video signal, it displays the odd lines (the odd field) first. Then it displays the even lines (the even field). Each pair forms a frame, and there are 60 of these fields displayed every second (or 30 frames every second). This is referred to as “interlaced” video. A computer monitor, however, uses a process called “progressive scan” to update the screen. With this method, the screen is not broken into fields. Instead, the computer displays each line in sequence, from top to bottom. This entire frame is displayed 30 times every second. This is often referred to as “non-interlaced” video.

Frame rates are used in synchronizing audio and pictures, whether film, television, or video. In motion pictures and television, the frame rates are standardized by the Society of Motion Picture and Television Editors (SMPTE). SMPTE Time Code frame rates of 24, 25, and 30 frames per second are common, each having uses in different sectors of the industry. The professional frame rate for motion pictures is 24 frames per second and, for television, 30 frames per second in the United States and 25 frames per second in Europe.

In computer video streams, the frame rate describes playback rates. The video playback rate directly relates to the perceived smoothness of the video. The higher the number of frames playing per second, the smoother the video playback appears to the user. Smoother video does not appear to be a series of different frames but, instead, appears as real-life, full-motion movement. Lower rates result in choppy playback.

Color resolution refers to the number of colors displayed on the screen at one time. Computers process color in an “RGB” (red-green-blue) format, while video uses a variety of formats. Typical RGB color resolutions are 8 bits/pixel (256 colors), 16 bits/pixel (65,535 colors), and 24 bits/pixel (16.7 million colors).

Spatial resolution determines the size of the viewable picture. As with RGB, there is no direct correlation between analog video resolutions and computer display resolutions. A standard analog video signal displays a full, over-scanned image without the borders common to computer screens. The National Television Standards Committee (NTSC) standard used in North American and Japanese television uses a 768×484 display. The Phase Alternative system (PAL) standard for European television is slightly larger at 768×576. Since the resolution between analog video and computers is different, conversion of analog video to digital video at times must take this into account. This can often result in the downsizing of the video and the loss of some resolution.

The last and ultimately most important factor is video quality. The final objective is video of acceptable appearance for a particular use. For some uses, this may be a ¼ screen, 15 frame per second video, at 8 bits per pixel. Other uses may require full screen (768×484), full frame rate video (24 or 30 frames per second), at 24 bits per pixel (16.7 million colors).

Achieving quality digital video requires significant computer processing power, memory, storage, and bandwidth. Bandwidth is the amount of data that can be transmitted in a fixed amount of time. Increased bandwidth will allow for an increase in the amount of data transferred. Bandwidth costs money, so that at higher bandwidth requirements, the per unit cost of bandwidth increases.

Compressing data allows for more information or data to be transmitted in a fixed amount of bandwidth. Thus, compression, even in small amounts, can produce significant savings in the form of computer processing power, memory, and transmission costs, as well as the more direct costs associated with increased bandwidth and greater storage requirements.

Compression allows for greater and more efficient use of existing technology, which is desired because of potential restrictions on the available bandwidth. Full-motion 525-line video, as used in North American television systems, needs about 200,000 Kbits for each second of video. If transmission is to be achieved over regular telephone lines using 56 Kbits/s modems, it would take about an hour to transmit a single second of high quality video. Thus, in order to view video in real time over the Internet, video data must be highly compressed. The lower the bandwidth, the more compression is required to produce broadcast quality video. Increased compression also allows digital video media to contain more video. It is, therefore, desired to have a method for compressing video in which the degree of compression is increased over current methods.

Video compression methods tend to be “lossy.” This means that what comes out after decoding is not identical to what was originally encoded because some data is “lost.” Video compression is the art of eliminating as much data as possible without the loss of that data being detectable by viewers.

With digital video, there is a tradeoff between image quality and file size. A file size is an amount of data contained in a file. Producing high quality video is comparatively easy at large file sizes. Also, producing video with small file sizes but lower quality is not difficult. The challenge lies in producing video with comparatively good image quality at smaller file sizes. The technology by which video compression is achieved is known as a “codec,” an abbreviation of compression/decompression. Various codecs have been developed—implementable in both software and hardware, and sometimes utilizing both—allowing video to be readily translated to and from its compressed state. Many video editing software programs today contain multiple codecs.

Compression methods have been developed which utilize various codecs. The limitations remain consistent, however. Increases in video resolution, color depth, frame rate, and image quality are generally accompanied by large file size, preventing wide use of the video.

Because of their cross-platform capability, compact discs (CDs) are ideal media for displaying digital video on suitably equipped personal computers, dedicated VCD players, and CD-i systems. Also, because of the greater prevalence of CD players than DVD players in current computers, especially laptops, there is a need for the ability to put digital video on CD.

Current compression methods do not allow multiple feature length (1.5 to 2 hours) movies to be stored on a single CD. A compression ratio is the ratio of a file's uncompressed size to the file's compressed size. The most efficient current compression techniques are able to compress digital video files with compression ratios as high as about 7:1, such that a typical 4-5 gigabyte (GB), 80-90 minute video file on a DVD occupies about 650 megabytes (MB) at a resolution of 640×480 pixels, making it difficult to store even a single feature length movie on a single normal CD.

Also, video files containing movies longer than about 90 minutes cannot be sufficiently compressed while maintaining viewable quality under current methods to fit on a single CD. In current compression methods, generally video data captured to the computer before compression is kept to a minimum file size. This is done under the assumption that if the starting file size is small, the final compressed file size will be minimized. To achieve a small file size upon capturing the video, often the video data rate specified is in the hundreds, typically less than 600 Kbps. In addition, other parameters are adjusted to minimize file size, with the result that the quality of video captured is also minimized. It is, therefore, desired to have a method of compressing video which minimizes the file size of the resultant compressed file while maintaining quality. Such a process would capture high quality video and compress the video so that the resulting file is compressed to a greater extent than current methods, while also achieving better viewable quality. For example, rolling text is easier to read because it appears smoother. In addition, all motion appears more continuous and less choppy. Also, images are not distorted.

To save on storage and to maximize CD utility, it is desired to have a method that compresses video sufficiently to allow storage of multiple two-hour feature length movies. For many companies and consumers, whether to present an employee training film or simply watch all three parts of a movie trilogy, it is desired to view video of longer duration than 90 minutes. To allow use of longer duration video, it is desired to have a method of compressing video, allowing five hours or more of video to be stored on a CD.

In addition, many current compression methods require access to the application that produced the compressed video file in order to view the video. This means that, unless the business or consumer possesses the original application, the compressed video file is worthless. Thus, it is desired to have a method of compressing video that allows for the compressed video to be easily read and displayed on multiple platforms and using multiple applications.

It is additionally desired to have a compression method for producing a video file which minimizes power consumption of a computer processing the video file. Minimizing power consumption allows for extended battery life of portable computers used to view the video. In addition, battery life can be extended for other video display devices, such as wireless handheld devices. In such devices, battery life is a critical factor in how much video can be processed by the device while a user is away from an electrical power outlet. For example, users of portable computers on airplane flights can only use video as long as the computer's battery is charged.

It is desired to have a method of compression which minimizes power consumption of a computer processing a video file by producing a video file that is not only smaller in file size, but that also has a smaller buffer. A buffer is the minimum amount of video data that can be processed. Current video files require a microprocessor, or CPU, of a computer processing the video file to process the video file with a 5 MB buffer. Such a buffer requires that the storage medium upon which the video file is stored be accessed once every second, or more frequently. By having a smaller buffer, the storage medium is not required to be accessed as frequently. Not accessing the storage medium as frequently requires less electrical power, because the processor is not used as often. Less usage of electrical power is desired because it allows for longer battery life.

It is also desired to have a compression method which minimizes power consumption of a computer processing the video file by producing a file of smaller file size than current methods. A smaller video file requires less electrical power in order to be processed. Thus, a video compression method minimizing file size of the resultant video also minimizes power consumption. By minimizing power usage, video may be watched for a longer period on battery power.

Small increases in compression over current methods would lead to major improvements for consumers wishing to view digital video on CD or over the Internet, as well as businesses communicating via videoconference or recording training seminars for their employees. Increased compression also allows digital video media to contain more video. It is, therefore, desired to have a method for compressing video in which the degree of compression is increased over current methods. It is also desired to have a method of compressing video which minimizes the file size of the resultant file while maintaining quality by obtaining high quality video during capture of the video. It is also desired to have a method that compresses video sufficiently to allow storage of multiple two-hour feature length movies. It is additionally desired to have a method of compressing video that allows for the compressed video to be easily read on multiple platforms and using multiple applications. Finally, it is desired to have a compression method producing a video file which minimizes power consumption of a computer processing the video file.

### SUMMARY OF INVENTION

This present invention is directed to a method and system for compressing video and resultant media. The invention provides for compressing video with a compression ratio of about 20:1. The method of compressing video minimizes the file size of the resultant file, while maintaining quality by obtaining high quality video during the capturing step. The method and system compress video sufficiently to allow storage of multiple two-hour feature length movies. The method and system also allow for the compressed video to be easily read on multiple platforms and using multiple applications. The invention includes a resultant compact disc containing up to about five hours of digital video. The method and system allow for the compression of video to levels previously not obtainable while, at the same time, maintaining the video at viewing quality. In addition, the resultant video file minimizes power consumption of a computer processing the video file.

### BRIEF DESCRIPTION OF DRAWINGS

FIG. 1 is a flowchart showing steps practiced in accordance with the present invention; and,

FIG. 2 is a block diagram showing a computer within a system upon which the apresent invention can be practiced.

### DETAILED DESCRIPTION

The present invention relates to a method and system for compressing video. More specifically, the invention relates to a method and system for capturing video to a computer and encoding and compressing the video to preferably about 5% of its original file size so that five hours of video fit on a single compact disc. The invention includes a resultant compact disc containing up to about five hours of digital video. Optionally, the video can be recorded to storage media, outputted to a display device, or both. The method and system allow for the compression of video to levels believed previously not obtainable while, at the same time, maintaining the video at high viewing quality.

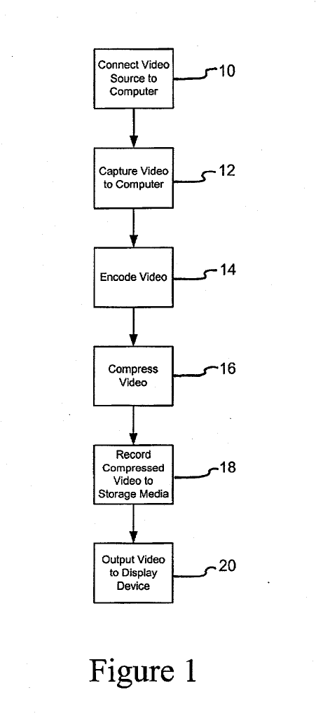

The method is initiated by connecting a video source to a computer 10, FIG. 1. As video can be viewed and stored in many ways, there are many sources to which the computer can be connected in order to initiate transfer of the video to the computer. Included among the possible video sources are a video cassette recorder (VCR), digital video recorder, camcorder, cable television, satellite television, Internet, web browser, computer storage device, broadcast television, digital versatile disc, video compact disc, video teleconferencing system, and medical imaging device. Any of a variety of sources may be used, as long as the source can be connected to a computer and video can be transferred thereto.

The video source is connected to the computer in a manner such that video can be transferred from the source to the computer. The specific connection method can vary according to the video source. For example, for a connection from a VCR to the computer, there are video and audio outputs from the VCR directly to the computer's video capture inputs. The type of video input depends on the type of input available on the computer used. Possible types of input connections include coaxial video, composite, S-Video, component, serial digital input, and FireWire®/IEEE-1394.

After the video source is connected to the computer, the video is transferred, or captured, to the computer 12. This step is usually done along with encoding the video 14 as a single step, but capturing and encoding may be done separately. The video is captured 12 and encoded 14 to the computer using a video editing application. Many such programs are acceptable for use with the present invention. Generally, the capturing step includes choosing the device type, such as a VCR, from which the video will be captured and where the video will be stored in the computer, generally a hard disk. It is preferred to have a separate hard disk with a storage capacity of 20 gigabytes or larger to store the video in order to maximize the speed of the compressing process, but any hard disk or other storage device is acceptable, as long as it is of sufficient size to store the captured video. The capturing process is then initiated by selecting the capture option in the video editing program, often by clicking “capture.”

The present method transfers as much video file information as possible during capturing and encoding. By obtaining maximum video file information at the outset, more information can be discarded during compression. This not only preserves the viewable quality of the video, but also minimizes the size of the resultant file. By having better quality video to work with from the beginning, the present method and system produce compressed video that is of higher viewable quality. Preserving image quality during the compression step is not as essential, since the original file retains more file information. Because of this shift of focus from preserving the file to making the file smaller, the resultant video file is smaller than files of similar viewable quality using other methods.

If the video is encoded at the same time that it is captured, as is preferred, then before the user initiates the capturing process, the video encoding parameters must be specified. If encoding is completed apart from capturing, these specifications must still be made, but they are made after the video is already recorded on the hard disk. Separating the encoding and capturing steps is optional.

Specifying the encoding parameters is an important step in the compression process, because without having video in the properly encoded form, the video compression step 16 will not be able to achieve a compression ratio of about 20:1. The user specifies the encoding parameters using the video editing application.

While the preferred frame rate is 29.97 frames per second, frame rates from about 3 to about 60 frames per second are acceptable. Also, although a resolution of 352×240 pixels is preferred, resolutions from as small as 80×120 pixels to as large as 720×480 pixels are possible. Though the preferred video data rate is 1,123 Kbps, allowable rates for the present invention range from about 600 to above 6,000 Kbps. The preferred audio data rate is 224 Kbps, but the rate can range from about 64 to about 400 Kbps. While 24-bit MPEG compression is preferred, 32-bit compression may also be used acceptably within the present method and system. Also, the preferred audio frequency is 44,100 Hz, corresponding to stereo audio, but other frequencies can be used, ranging from 11,000 Hz, corresponding to 8-bit mono audio, to above 48,000 Hz. Once these specifications have been made using the video editing program, video capture 12 is initiated by issuing a command to begin the capture using the video editing program.

Once the video is encoded 14, the video is compressed 16 using the video editing application. Again, it is important to specify the compression parameters using the video editing program so that maximum compression and quality are obtained in the video produced. It is preferred to specify a key frame every 0 seconds. However, it is allowable within the present method and system to specify that every frame is made a key frame. It is also acceptable to specify a key frame every 30 seconds, as well as all combinations between these extremes. Also, although specification of compression control of 100% crispness is preferable, crispness of as low as about 40%, as well as intermediate percentages, are acceptable. The preferred data rate is 3000 Kbps, but a range of about 1000 to about 6000 Kbps is allowable. Also, 24-bit RGB color resolution is preferred, but other resolutions may be used, including 32-bit RGB. In addition, although advanced streaming format is preferred due to its ability to be used across a variety of platforms, other file formats may be used to save and store the data. Specifying that the resultant video be of advanced streaming format makes the video available to a wider audience with greater ease, and also allows for maximum compression. Advanced streaming format allows video storage on and delivery over multiple networks and protocols.

Upon specification of the encoding and compression parameters, as described, the present invention results in a compressed video file which minimizes electrical power consumption of a computer processing the video file. The invention minimizes electrical power consumption of a computer processing the video file by producing a file that is of smaller file size and that requires a smaller buffer. The buffer required by a video file produced by the present method and system is about 300 KB. This requires a CPU of a computer processing the video file to access the media on which the video file is stored preferably about every 20-25 seconds, and optionally every 25-40 seconds. Accessing the storage less frequently requires less electrical power because the CPU is not used as often. Less frequent usage of electrical power is desired because it allows for longer battery life. By minimizing power usage, video may be watched for a longer period on battery power.

The compressed video is then recorded to storage media 18. Any storage media compatible with the computer is acceptable, including such devices as hard disks, removable storage such as Zip® disks, tape drives, disk drives accessible over the Internet, compact discs (CDs), digital versatile discs (DVDs), and any computer media capable of holding sufficient amounts of data. The compressed video is stored on the storage media, and may optionally be further recorded on portable media, such as Zip® disks, compact discs, and DVDs. The purpose of transferring the compressed video to portable media is to take full advantage of the compression achieved. For instance, three feature length movies can be stored on a single CD. Thus, a user can take a single CD on an airplane and watch 5 hours of video. The compressed video may optionally be displayed over a computer network, including an intranet, extranet, or the Internet.

A CD or DVD containing compressed video is a resultant product of the present method and system. The compression ratio is about 20:1, so that about five hours of video can be stored on a single CD. As such, a CD or DVD is produced containing video having a compression ratio of about 20:1.

After the compressed video is recorded, the video is outputted to a display device 20. Such display devices may include computer monitor display, video cassette recorder, digital video recorder, camcorder, cable television, satellite television, Internet, computer display device, television display device, web browser, computer storage device, broadcast television, digital versatile disc, video compact disc, video teleconferencing system, and medical imaging device.

Display using such display devices may be optionally done over a computer network. This allows a business to broadcast such content to multiple users at varying times. Because of the degree of compression, more video can be stored for viewing in the same storage space than was previously possible. A video file is any recordation of video on a computer or any electronic device. When a video file is specified, such specification includes any number of video files and is not limited to a single video file.

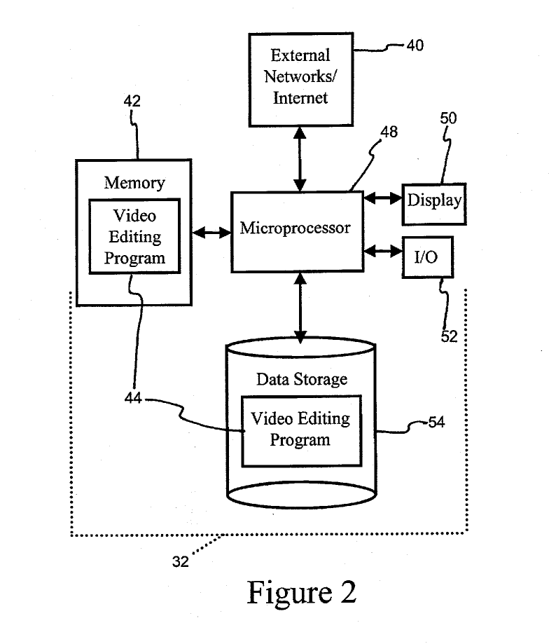

The computer 32, FIG. 2 in the present invention, can be a personal computer, computer workstation, or other suitable computing device. The computer 32 includes a microprocessor 48, memory 42, data storage 54, a display 50, I/O (input/output) 52, and external networks/Internet 40. Typical data storage 54 includes mass storage devices, such as hard disks, as well as removable media devices, such as removable hard disks, compact discs, and digital versatile discs. I/O 52 describes any operation, program, or device that transfers data to or from a computer. Typical I/O devices are printers, hard disks, keyboards, and mice. External networks/Internet 40 typically includes a connection to the Internet, as well as internal and/or external network connections. The Internet connection can be of any type by which the computer 32 can communicate with other computers on the Internet, such as dial-up connections, direct connections, cable service connections, and digital subscriber lines. The network connections can include local-area networks (LANs), wide-area networks (WANs), campus-area networks (CANs), metropolitan-area networks (MANs), and home-area networks (HANs). The network connections may overlap with the Internet connections such that a network connection is used to access the Internet. The computer 32 could include other computer components as well. The computer 32 also has audio and video inputs and, optionally, audio and video outputs.

A suitable microprocessor 48 is a single Intel® Pentium® processor running at a minimum of 500 MHz, although the present invention can be used with other microprocessors as well. The microprocessor 48 is connected to the memory 42. The memory 42 is typically Dynamic Random Access Memory (DRAM) or Synchronous Dynamic Random Access Memory (SDRAM) configured in Single Inline Memory Modules (SIMM) and consists of a minimum of 128 megabytes (MB). The preferred embodiment of the present invention is implemented on the Microsoft® Windows® 2000. Other operating systems can be employed.

Data storage 54 stores data representing a video editing program 44 according to the present invention. The video editing program 44 can be stored in memory 42 rather than needing to access data storage 54.

Thus, there has been shown and described a method and system for compressing video and resultant media, which fulfills all the objects and advantages sought therefor. It is apparent to those skilled in the art, however, that many changes, variations, modifications, and other uses and applications for the method and system of compressing video and resultant media are possible, and also such changes, variations, modifications, and other uses and applications, which do not depart from the spirit and scope of the invention are deemed to be covered by the invention, which is limited only by the claims which follow.

1. A method for capturing and compressing video, whereby the resultant compression ratio is between about 3:1 and 33:1, wherein the method comprises capturing video from a video source and compressing the video, using a video editing program specifying the following parameters: maximum frame rate of 29.97 frames per second, maximum rgb color resolution of 24 bits per pixel, and maximum spatial resolution of 352×240 pixels.

2. A method for compressing video, wherein a video file is compressed with a compression ratio between about 3:1 and 33:1 comprising:
(a) capturing video from a video source, specifying a frame rate of 29.97 frames per second, a spatial resolution of 352×240 pixels, a video data rate of 1123 Kbps, an audio data rate of 224 Kbps, 24-bit MPEG-2 compression, and audio frequency of 44100 Hz;
(b) compressing the video using a video editing program specifying a key frame every 0 seconds, compression control of 100% crispness, data rate of 3000 Kbps, RGB color resolution of 24 bits per pixel, and advanced streaming format video type; and,
(c) transferring the compressed video to a display device.

3. A method for compressing video, wherein a video file is compressed with a compression ratio between about 3:1 and 33:1 comprising:
(a) connecting a video source to a computer;
(b) capturing video to the computer using a video editing program, specifying a frame rate of 29.97 frames per second, a spatial resolution of 352×240 pixels, a video data rate of 1123 Kbps, an audio data rate of 224 Kbps, 24-bit MPEG-2 compression, and audio frequency of 44100 Hz;
(c) compressing the video using a video editing program specifying a key frame every 0 seconds, compression control of 100% crispness, data rate of 3000 Kbps RGB color resolution of 24 bits per pixel, and advanced streaming format video type;
(d) recording the compressed video to storage media; and,
(e) outputting the compressed video to a display device.

4. The method of claim 3, wherein the video source is selected from the group consisting of video cassette recorder, digital video recorder, camcorder, cable television, satellite television, Internet, web browser, computer storage device, broadcast television, digital versatile disc, video compact disc, video teleconferencing system, medical imaging device, and combinations thereof.

5. The method of claim 3, wherein the display device is selected from the group consisting of personal computer, computer monitor display, video cassette recorder, digital video recorder, camcorder, cable television, satellite television, Internet, computer display device, television display device, cellular telephone, personal digital assistant, portable computer, web browser, computer storage device, broadcast television, digital versatile disc, video compact disc, video teleconferencing system, medical imaging device, and combinations thereof.

6. The method of claim 3, wherein the compressed video is displayed over a computer network.

7. The method of claim 3, wherein the compressed video is in a multimedia file format that supports data delivery over multiple networks and protocols.

8. The method of claim 7, wherein the multimedia file format is advanced streaming format.

9. A method for compressing video, wherein a video file is compressed with a compression ratio between about 3:1 and 33:1 comprising:
(a) capturing video from a video source, specifying a frame rate of between about 3 frames per second and about 60 frames per second, a spatial resolution of between about 80×120 pixels and about 720×480 pixels, a video data rate of between about 600 Kbps and about 6000 Kbps, an audio data rate between about 64 Kbps and about 400 Kbps, between about 24-bit and about 32-bit MPEG-2 compression, and audio frequency of between about 11000 Hz and about 48000 Hz;
(b) compressing the video using a video editing program specifying a key frame between specifying every frame a key frame and specifying a key frame every 30 seconds, compression control of 100% to about 40% crispness, data rate of between about 1000 Kbps to about 6000 Kbps, RGB color resolution of between about 24 bits per pixel and 32 bits per pixel, and advanced streaming format video type; and,
(c) transferring the compressed video to a display device.

10. A method for compressing video, wherein a video file is compressed with a compression ratio between about 3:1 and 33:1 comprising:
(a) connecting a video source to a computer;
(b) capturing video to the computer using a video editing program, specifying a frame rate of between about 3 frames per second and about 60 frames per second, a spatial resolution of between about 80×120 pixels and about 720×480 pixels, a video data rate of between about 600 Kbps and about 6000 Kbps, an audio data rate between about 64 Kbps and about 400 Kbps, between about 24-bit and about 32-bit MPEG-2 compression, and audio frequency of between about 11000 Hz and about 48000 Hz;
(c) compressing the video using a video editing program specifying a key frame between specifying every frame a key frame and specifying a key frame every 30 seconds, compression control of 100% to about 40% crispness, data rate of between about 1000 Kbps to about 6000 Kbps, RGB color resolution of between about 24 bits per pixel and 32 bits per pixel, and advanced streaming format video type;
(d) recording the compressed video to storage media; and,
(e) outputting the compressed video to a display device.

11. The method of claim 10, wherein the video source is selected from the group consisting of video cassette recorder, digital video recorder, camcorder, cable television, satellite television, Internet, web browser, computer storage device, broadcast television, digital versatile disc, video compact disc, video teleconferencing system, medical imaging device, and combinations thereof.

12. The method of claim 10, wherein the display device is selected from the group consisting of personal computer, computer monitor display, video cassette recorder, digital video recorder, camcorder, cable television, satellite television, Internet, computer display device, television display device, cellular telephone, personal digital assistant, portable computer, web browser, computer storage device, broadcast television, digital versatile disc, video compact disc, video teleconferencing system, medical imaging device, and combinations thereof.

13. The method of claim 10, wherein the compressed video is displayed over a computer network.

14. The method of claim 10, wherein the compressed video is in a multimedia file format that supports data delivery over multiple networks and protocols.

15. The method of claim 14, wherein the multimedia file format is advanced streaming format.

16. A video file compressed with a compression ratio between about 3:1 and 33:1 containing video with a maximum frame rate of 29.97 frames per second, maximum RGB color resolution of 24 bits per pixel, and maximum spatial resolution of 352×240 pixels.

17. A video file compressed with a compression ratio between about 3:1 and 33:1 containing video with a frame rate of 29.97 frames per second, a spatial resolution of 352×240 pixels, a video data rate of 1123 Kbps, an audio data rate of 224 Kbps, 24-bit MPEG-2 compression, audio frequency of 44100 Hz, key frame every 0 seconds, compression control of 100% crispness, data rate of 3000 Kbps, and RGB color resolution of 24 bits per pixel.

18. The video file of claim 17, wherein the compressed video file is viewed using a web browser.

19. The video file of claim 17, wherein the compressed video is displayed over a computer network.

20. The video file of claim 17, wherein the compressed video file is in a multimedia file format that supports data delivery over multiple networks and protocols.

21. The video file of claim 20, wherein the multimedia file format is advanced streaming format.

22. A video file compressed with a compression ratio between about 3:1 and 33:1 containing video with a frame rate of between about 3 frames per second and about 60 frames per second, between about 24-bit and about 32-bit MPEG-2 compression, and a spatial resolution of between about 80×120 pixels and about 720×480 pixels.

23. A video file compressed with a compression ratio between about 3:1 and 33:1 containing video with a frame rate of between about 3 frames per second and about 60 frames per second, a spatial resolution of between about 80×1 20 pixels and about 720×480 pixels, a video data rate of between about 600 Kbps and about 6000 Kbps, an audio data rate between about 64 Kbps and about 400 Kbps, between about 24-bit and about 32-bit MPEG-2 compression, and audio frequency of between about 11000 Hz and about 48000 Hz.

24. The video file of claim 23, wherein the compressed video file is viewed using a web browser.

25. The video file of claim 23, wherein the compressed video is displayed over a computer network.

26. The video file of claim 23, wherein the compressed video file is in a multimedia file format that supports data delivery over multiple networks and protocols.

27. The video file of claim 26, wherein the multimedia file format is advanced streaming format.

28. A compact disc containing between 90 minutes and five hours of video in which the video has a frame rate of 29.97 frames per second, RGB color resolution of 24 bits per pixel, and a spatial resolution of 352×240 pixels.

29. A compact disc containing a video file compressed with a compression ratio between about 3:1 and 33:1 with a frame rate of 29.97 frames per second, a spatial resolution of 352×240 pixels, a video data rate of 1123 Kbps, an audio data rate of about 224 Kbps, 24-bit MPEG-2 compression, and audio frequency of 44100 Hz, a key frame every 0 seconds, compression control of 100% crispness, data rate of about 3000 Kbps, and RGB color resolution of 24 bits per pixel.

30. The compact disc of claim 29, wherein the compressed video file is viewed using a web browser.

31. The compact disc of claim 29, wherein the compressed video file is in a multimedia file format that supports data delivery over multiple networks and protocols.

32. The compact disc of claim 31, wherein the multimedia file format is advanced streaming format.

33. A compact disc containing between 90 minutes and five hours of video in which the video has a frame rate of between about 3 frames per second and about 60 frames per second, between about 24-bit and about 32-bit MPEG-2 compression, and a spatial resolution of between about 80×120 pixels and about 720×480 pixels.

34. A compact disc containing a video file compressed with a compression ratio between about 3:1 and 33:1, with a frame rate of between about 3 frames per second and about 60 frames per second, a spatial resolution of between about 80×120 pixels and about 720×480 pixels, a video data rate of between about 600 Kbps and about 6000 Kbps, an audio data rate between about 64 Kbps and about 400 Kbps, between about 24-bit and about 32-bit MPEG-2 compression, and audio frequency of between about 11000 Hz and about 48000 Hz.

35. The compact disc of claim 34, wherein the compressed video file is viewed using a web browser.

36. The compact disc of claim 34, wherein the compressed video file is in a multimedia file format that supports data delivery over multiple networks and protocols.

37. The compact disc of claim 36, wherein the multimedia file format is advanced streaming format.

38. A DVD containing a video file compressed with a compression ratio between about 3:1 and 33:1, with a frame rate of 29.97 frames per second, a spatial resolution of 352×240 pixels, a video data rate of 1123 Kbps, an audio data rate of about 224 Kbps, 24-bit MPEG-2 compression, and audio frequency of 44100 Hz, a key frame every 0 seconds, compression control of 100% crispness, data rate of about 3000 Kbps, and RGB color resolution of 24 bits per pixel.

39. A DVD containing a video file compressed with a compression ratio between about 3:1 and 33:1, with a frame rate of between about 3 frames per second and about 60 frames per second, a spatial resolution of between about 80×120 pixels and about 720×480 pixels, a video data rate of between about 600 Kbps and about 6000 Kbps, an audio data rate between about 64 Kbps and about 400 Kbps, between about 24-bit and about 32-bit MPEG-2 compression, and audio frequency of between about 11000 Hz and about 48000 Hz.

40. A system for compressing video, wherein a video file is compressed with a compression ratio between about 3:1 and 33:1 comprising:
(a) a video editing program for capturing video from a video source and specifying a frame rate of 29.97 frames per second, a spatial resolution of 352×240 pixels, a video data rate of 1123 Kbps, an audio data rate of 224 Kbps, 24-bit MPEG-2 compression, and audio frequency of 44100 Hz, and for compressing the video and specifying a key frame every 0 seconds, compression control of 100% crispness, data rate of 3000 Kbps, RGB color resolution of 24 bits per pixel, and advanced streaming format video type; and,
(b) a medium for containing and displaying the compressed video.

41. The system of claim 40, wherein the video source is selected from the group consisting of video cassette recorder, digital video recorder, camcorder, cable television, satellite television, Internet, web browser, computer storage device, broadcast television, digital versatile disc, video compact disc, video teleconferencing system, medical imaging device, and combinations thereof.

42. The system of claim 40, wherein the medium for containing and displaying the compressed video is selected from the group consisting of video cassette recorder, digital video recorder, camcorder, cable television, satellite television, Internet, computer display device, television display device, web browser, computer storage device, broadcast television, digital versatile disc, video compact disc, video teleconferencing system, medical imaging device, and combinations thereof.

43. A system for compressing video, wherein a video file is compressed with a compression ratio between about 3:1 and 33:1 comprising:
(a) a video editing program for capturing video from a video source and specifying frame rate of between about 3 frames per second and about 60 frames per second, a spatial resolution of between about 80×1 20 pixels and about 720×480 pixels, a video data rate of between about 600 Kbps and about 6000 Kbps, an audio data rate between about 64 Kbps and about 400 Kbps, between about 24-bit and about 32-bit MPEG-2 compression, and audio frequency of between about 11000 Hz and about 48000 Hz, and for compressing the video using a video editing program specifying a key frame between specifying every frame a key frame and specifying a key frame every 30 seconds, compression control of 100% to about 40% crispness, data rate of between about 1000 Kbps to about 6000 Kbps, RGB color resolution of between about 24 bits per pixel and 32 bits per pixel, and advanced streaming format video type; and,
(b) a medium for containing and displaying the compressed video.

44. A method for capturing and compressing video, wherein a buffer required by a computer processing a resultant video file having a compression ratio between about 3:1 and 33:1 is about 300 KB.

45. A compact disc containing a video file compressed with a compression ratio between about 3:1 and 33:1, wherein a buffer required by a computer processing the video file is about 300 KB.
